(19) United States
(12) Patent Application Publication
(10) Pub. No.: US 2020/0139444 A1
(43) Pub. Date: May 7, 2020

(54) Method for manufacturing magnetic powder core

(71) Applicants: Changqing Sun, Shenzhen (CN); Lili Chen, Shenzhen (CN)

(72) Inventors: Changqing Sun, Shenzhen (CN); Lili Chen, Shenzhen (CN)

(21) Appl. No.: 16/718,141

(22) Filed: Dec. 17, 2019

(30) Foreign Application Priority Data
Feb. 15, 2019 (CN) 201910117640.3

(51) Int. Cl. B22F 9/02; H01F 1/147

(52) U.S. Cl. CPC B22F 9/02; H01F 1/14791

(57) ABSTRACT

A method for manufacturing a sendust core using a sendust core material including aerosolized sendust powder having granularity of 5-20 microns, having a spherical shape, and having 8.5-10.0% of silicon, 5.5-6.3% of aluminum, and a balance of iron includes heating the sendust powder to 60-100° C.; preparing a binder; mixing the binder with the clay powder; adding a powdered lubricant into the finished powder and mixing same; and heat treating the pressed blank in a sintering furnace to obtain the sendust core.

### BACKGROUND OF THE INVENTION

### 1. Field of the Invention

The invention relates to relates to methods for selecting magnetic materials distinguished by components and manufacturing a magnetic powder core, and more particularly to a sendust core material with low magnetoconductivity and a method for manufacturing a magnetic powder core.

### 2. Description of Related Art

A metal magnetic powder core is a soft magnetic composite obtained by forming and heat treating a mixture of metal soft magnetic powder and insulated binder. The metal magnetic powder core is an essential key component in electronic equipment due to the fact that it has been widely applied to switching power converter, filter, AC/DC converter, DC/DC converter, etc.

Due to excellent performance and reasonable price, the sendust core has been widely applied to various fields, such as power electronics, frequency conversion equipment, inverter and aerospace. In the present market, there are five sendust powder cores with magnetoconductivities as 26, 60, 75, 90 and 125. The sendust core is mainly composed of sendust powder and an insulating substance, and can be divided into an ordinary sendust core and a super sendust core according to the differences of the sendust powder. The sendust powder in the ordinary sendust core is prepared with a crushing method, while the sendust powder in the super sendust core is prepared with an atomization method. The ordinary sendust core is slightly low in cost, but its DC superposition and loss characteristics are slightly worse than that of the super sendust core prepared by atomized powder. Since the super sendust core is made of the atomized powder, its powder is of a spherical shape and the particle size range is narrow. For this, although the super sendust core is good in electrical property, its powder is poor in formability and mechanical strength due to high rigidity.

Thus, the need for improvement still exists.

### SUMMARY OF THE INVENTION

To solve the above technical problem, the invention puts forward a sendust core material with low magnetoconductivity and a method for manufacturing a magnetic powder core. The sendust core obtained by using the sendust core material and the manufacturing method thereof has good electrical and mechanical properties.

To achieve the above purpose, the technical solution of the invention is as follows:

A sendust core material with low magnetoconductivity, comprising aerosolized sendust powder, wherein the sendust powder, with granularity of 5-20 microns, is of a spherical shape and contains 8.5-10.0% silicon, 5.5-6.3% aluminum and the balance of iron.

The sendust powder contains 8.5-9.0% silicon, 5.5-6.0% aluminum and the balance of iron.

A method for manufacturing a sendust core using the sendust core material, including the steps of taking the sendust powder to heat to 60-100° C., adding an aqueous solution mixed with chromic acid, phosphoric acid and boric acid into the powder and stirring to allow the two to produce chemical reaction for 30-60 min, and then taking out the reacted powder to roast for 1-2 h at 100-200° C., so as to obtain a first powder; preparing a binder, wherein the binder is composed of sodium silicate, alumina powder, calcium aluminate cement and montmorillonoid, the mass ratio of sodium silicate to alumina powder to calcium aluminate cement to montmorillonoid is (5-6):(2.8-3.5):(1.8-2.5):(0.7-2.0), and the sodium silicate modulus is 1.5-2.5; mixing the binder with the clay powder uniformly, then mixing with the water to make into mixed liquid, and mixing the air-dried first powder with the mixed liquid, wherein the mass ratio of the binder to the first powder is 1.0-2.5%, the mass ratio of the clay powder to the first powder is 2.0-5.0%, and the mass ratio of the water to the first powder is 5.0-10.0%; taking out and drying at 100-150° C. after stirring for 30-60 min, and screening with a 60-mesh sieve to obtain finished powder after drying; adding a powdered lubricant into the finished powder, uniformly mixing, respectively screening with the 60-mesh sieve, and then placing into a die cavity of a press mold to obtain a blank by pressing; heat treating the pressed blank in a sintering furnace to obtain the sendust core.

In the process of obtaining the first powder, the mass ratio relationship between the sendust powder and the aqueous solution mixed with chromic acid, phosphoric acid and boric acid is as follows: the mass ratio of the chromic acid to the sendust powder is 0.3%-1.5%, the mass ratio of the phosphoric acid to the sendust powder is 6.0-9.0%, the mass ratio of the boric acid to the sendust powder is 0.3-2.0%, and the mass ratio of the water to the sendust powder is 5.0-10.0%.

A method for manufacturing a sendust core using the sendust core material, including the steps of taking the sendust powder to heat to 60-100° C., adding an aqueous solution mixed with chromic acid, phosphoric acid and boric acid into the powder and stirring to allow the two to produce chemical reaction for 30-60 min, and then taking out the reacted powder to roast for 1-2 h at 100-200° C., so as to obtain a first powder; heat treating the first powder to obtain an intermediate powder; preparing a binder, wherein the binder is composed of sodium silicate, alumina powder, calcium aluminate cement and montmorillonoid, the mass ratio of sodium silicate to alumina powder to calcium aluminate cement to montmorillonoid is (5-6):(2.8-3.5):(1.8-2.5):(0.7-2.0), and the sodium silicate modulus is 1.5-2.5; mixing the binder with the clay powder uniformly, then mixing with the water to make into mixed liquid, and mixing the intermediate powder with the mixed liquid, taking out and drying at 100-150° C. after stirring for 30-60 min, and screening with the 60-mesh sieve to obtain the finished powder after drying; adding a powdered lubricant into the finished powder, uniformly mixing, screening with the 60-mesh sieve, and then placing into a die cavity of a press mold to obtain a blank by pressing, finally heat treating the pressed blank in the sintering furnace to obtain the sendust core; heat treating the first powder to obtain an intermediate powder, including the steps of placing the first powder in air at 400-600° C. for 1-3 h, so as to obtain a second powder; or placing the first powder in nitrogen at 700-800° C. for 1-3 h, so as to obtain a third powder.

The mass ratio of the binder to the second powder is 1.0-2.5%, the mass ratio of the clay powder to the second powder is 1.0-3.0%, and the mass ratio of the water to the second powder is 5.0-10.0%; or the mass ratio of the binder to the third powder is 1.0-2.5%, the mass ratio of the clay powder to the third powder is 1.0-3.0%, and the mass ratio of the water to the third powder is 5.0-10.0%.

A method for manufacturing a sendust core using the sendust core material, including the steps of taking the sendust powder to heat to 60-100° C., adding an aqueous solution mixed with chromic acid, phosphoric acid and boric acid into the powder and stirring to allow the two to produce chemical reaction for 30-60 min, and then taking out the reacted powder to roast for 1-2 h at 100-200° C., so as to obtain a first powder; placing the first powder in nitrogen at 700-800° C. for 1-3 h, so as to obtain a third powder; adding an acetone mixture with superfine oxide and resin into the air-dried third powder and stirring for 30-60 min to obtain a secondary insulated powder, placing the secondary insulated powder into a ventilated environment, screening with a 40-mesh sieve when the liquid content in the secondary insulation powder is 1-3%, and then air-drying the screened powder to obtain finished powder; adding a powdered lubricant into the finished powder, uniformly mixing, screening with the 60-mesh sieve, and then placing into a die cavity of a press mold to obtain a blank by pressing, finally heat treating the pressed blank in the sintering furnace to obtain the sendust core.

The resin is epoxy resin, phenolic resin or silicone resin. The superfine oxide contains at least one of nanoscale silica, nanoscale alumina, nanoscale magnesium dioxide, mica powder, kaolin, montmorillonoid and kieselguhr, and the particle size of the superfine oxide is less than 20 microns.

The resin is 0.5-2.0% by mass of the third powder, the superfine oxide is 0.8-5.0% by mass of the third powder, and the acetone is 5.0-10.0% by mass of the third powder.

The invention has the following beneficial effects: the process is simple; a layer of dense oxidation film is formed on the product surface after the sendust powder is passivated by the aqueous solution mixed with chromic acid, phosphoric acid and boric acid, the oxidation film is closely in contact with a surface of the sendust powder by a chemical bond, and the passivated powder is heat treated at certain temperature, so that the oxidation film on the surface of the powder is more uniformly covered on the surface of the sendust powder in such a manner of being difficult to peel. The sendust core obtained by the above preparation method is good both in electromagnetic property and mechanical strength.

### DETAILED DESCRIPTION OF THE INVENTION

To enable better understanding of the technical solution of the invention, the following paragraphs will illustrate the invention with the specific embodiments.

A sendust core material with low magnetoconductivity, comprising aerosolized sendust powder, wherein the sendust powder, with granularity of 5-20 microns, is of a spherical shape and contains 8.5-10.0% silicon, 5.5-6.3% aluminum and the balance of iron.

The sendust powder contains 8.5-9.0% silicon, 5.5-6.0% aluminum and the balance of iron.

A method for manufacturing a sendust core using the sendust core material, including the steps of taking the sendust powder to heat to 60-100° C., adding an aqueous solution mixed with chromic acid, phosphoric acid and boric acid into the sendust powder and stirring to allow the two to produce chemical reaction for 30-60 min, and then taking out the reacted sendust powder to roast for 1-2 h at 100-200° C., so as to obtain a first powder; in the process of obtaining the first powder, the mass ratio relationship between the sendust powder and the aqueous solution mixed with chromic acid, phosphoric acid and boric acid is as follows: the mass ratio of the chromic acid to the sendust powder is 0.3%-1.5%, the mass ratio of the phosphoric acid to the sendust powder is 6.0-9.0%, the mass ratio of the boric acid to the sendust powder is 0.3-2.0%, and the mass ratio of the water to the sendust powder is 5.0-10.0%; preparing a binder, wherein the binder is composed of sodium silicate, alumina powder, calcium aluminate cement and montmorillonoid, the mass ratio of sodium silicate to alumina powder to calcium aluminate cement to montmorillonoid is (5-6):(2.8-3.5):(1.8-2.5):(0.7-2.0), and the sodium silicate modulus is 1.5-2.5; mixing the binder with the clay powder uniformly, then mixing with the water to make into mixed liquid, and mixing the air-dried first powder with the mixed liquid, wherein the mass ratio of the binder to the first powder is 1.0-2.5%, the mass ratio of the clay powder to the first powder is 2.0-5.0%, and the mass ratio of the water to the first powder is 5.0-10.0%; taking out and drying at 100-150° C. after stirring for 30-60 min, and screening with a 60-mesh sieve to obtain a finished powder—a fourth powder. The clay powder may be one or mixture of several of mica powder, kaolin powder, montmorillonoid powder and feldspar powder; adding a powdered lubricant into the fourth powder, wherein the mass ratio of the powdered lubricant to the fourth powder is 0.3-0.7%; uniformly mixing; respectively screening with the 60-mesh sieve; and then placing into a die cavity of a press mold to obtain a blank by pressing, wherein the forming process conditions of obtaining the blank by pressing include that the pressure is 15-20 T/cm² and the holdup time is 3-5 s; heat treating the pressed blank in a sintering furnace to obtain the sendust core. The heat treatment conditions are as follows: roasting the blank for 1-5 h at 300-500° C.; rising to 700-900° C. for sintering in nitrogen, roasting for 1-2 h.

### Embodiment 1a

A method for manufacturing a magnetic powder core using the sendust core material, including the steps of 1) taking atomized sendust powder, with granularity of 5-20 microns, which is of a spherical shape; placing the sendust powder into a stirrer to heat to 60° C., wherein the sendust powder contains 8.5% silicon, 6.3% aluminum and the balance of iron; 2) adding an aqueous solution mixed with phosphoric acid and chromic acid into the sendust powder in step 1), wherein the chromic acid is 0.3% of the sendust powder, the phosphoric acid is 6.0% of the sendust powder, the boric acid is 0.3% of the sendust powder, and the water is 5.0% of the sendust powder; continuously stirring to allow full chemical reaction between the mixture and the sendust powder at 60° C. after addition; roasting the powder for 2 h at 100-200° C. after stirring for 60 min, so as to obtain a sendust powder after being insulated once, namely the first powder; 3) preparing a binder, wherein the binder is composed of sodium silicate, alumina powder, calcium aluminate cement and montmorillonoid, the mass ratio of sodium silicate to alumina powder to calcium aluminate cement to montmorillonoid is 5:2.8:1.8:0.7, and the sodium silicate modulus is 1.5; taking the binder which is 2.5% of the sendust powder; taking 1250-mesh mica powder, which is 5.0% of the sendust powder; taking water, which is 5.0% of the sendust powder; mixing and stirring the binder, the mica powder and the water uniformly; adding the mixture into the powder in step 2), stirring for 30 min at 80° C.; roasting the powder for 1.0 h at 100° C.; screening the dried powder with the 60-mesh sieve to obtain a finished powder—a fourth powder; 4) adding 0.30% powdered lubricant into the powder in step 3), and mixing uniformly; 5) placing the mixed powder obtained in step 4) into a mold cavity for dry pressing and forming, so as to obtain a sendust core blank, wherein the pressing and forming pressure is 20 T/cm², and the holdup time is 3-5 s; 6) heat treating the pressed blank in a sintering furnace with nitrogen, wherein the specific procedures include roasting the product for 5 h at 300° C., rising to 700° C. and roasting for 120 min; after the product taken from roasting is cooled, spraying a layer of epoxy resin on the surface of the product for preparation of the sendust core.

### Embodiment 1b

A method for manufacturing a magnetic powder core using the sendust core material, including the steps of 1) taking atomized sendust powder, with 5-20 microns, which is of a spherical shape; placing the sendust powder into a stirrer to heat to 80° C., wherein the sendust powder contains 9.0% silicon, 6.0% aluminum and the balance of iron; 2) adding an aqueous solution mixed with phosphoric acid and chromic acid into the sendust powder in step 1), wherein the chromic acid is 1.5% of the sendust powder, the phosphoric acid is 8.0% of the sendust powder, the boric acid is 1.5% of the sendust powder, and the water is 7.0% of the sendust powder; continuously stirring to allow full chemical reaction between the mixture and the sendust powder at 80° C. after addition; roasting the powder for 1.5 h at 150° C. (changed to 100-200° C.) after stirring for 40 min, so as to obtain a sendust powder after being insulated once, namely the first powder; 3) preparing a binder, wherein the binder is composed of sodium silicate, alumina powder, calcium aluminate cement and montmorillonoid, the mass ratio of sodium silicate to alumina powder to calcium aluminate cement to montmorillonoid is 6:3.5:2.5:2.0, and the sodium silicate modulus is 2.0%; taking the binder which is 1.5% of the sendust powder; taking 1250-mesh mica powder, which is 2.5% of the sendust powder; taking water, which is 7.0% of the sendust powder; mixing and stirring the binder, the mica powder and the water uniformly; adding the mixture into the powder in step 2), stirring for 60 min at 80° C.; roasting the powder for 1.0 h at 120° C.; screening the dried powder with the 60-mesh sieve to obtain a finished powder—a fourth powder; 4) adding 0.40% powdered lubricant into the powder in step 3), and mixing uniformly; 5) placing the mixed powder obtained in step 4) into a mold cavity for dry pressing and forming, so as to obtain a sendust core blank, wherein the pressing and forming pressure is 20 T/cm², and the holdup time is 3-5 s; 6) heat treating the pressed blank in a sintering furnace with nitrogen, wherein the specific procedures include roasting the product for 120 min at 450° C., rising to 750° C. and roasting for 80 min; after the product taken from roasting is cooled, spraying a layer of epoxy resin on the surface of the product for preparation of the sendust core.

### Embodiment 1c

A method for manufacturing a magnetic powder core using the sendust core material, including the steps of 1) taking atomized sendust powder, with 5-20 microns, which is of a spherical shape; placing the sendust powder into a stirrer to heat to 100° C., wherein the sendust powder contains 10.0% silicon, 5.5% aluminum and the balance of iron; 2) adding an aqueous solution mixed with phosphoric acid and chromic acid into the sendust powder in step 1), wherein the chromic acid is 1.5% of the sendust powder, the phosphoric acid is 9.0% of the sendust powder, the boric acid is 2.0% of the sendust powder, and the water is 10.0% of the sendust powder; continuously stirring to allow full chemical reaction between the mixture and the sendust powder at 100° C. after addition; roasting the powder for 1.0 h at 200° C. after stirring for 30 min, so as to obtain a sendust powder after being insulated once, namely the first powder; 3) preparing a binder, wherein the binder is composed of sodium silicate, alumina powder, calcium aluminate cement and montmorillonoid, the mass ratio of sodium silicate to alumina powder to calcium aluminate cement to montmorillonoid is 6:3.5:2.5:2.0, and the sodium silicate modulus is 2.5; taking the binder which is 1.0% of the sendust powder; taking 1250-mesh mica powder, which is 2.0% of the sendust powder; taking water, which is 10.0% of the sendust powder; mixing and stirring the binder, the mica powder and the water uniformly; adding the mixture into the powder in step 2), stirring for 30 min at 80° C.; roasting the powder for 1.0 h at 150° C.; screening the dried powder with the 60-mesh sieve to obtain a finished powder—a fourth powder; 4) adding 0.70% powdered lubricant into the powder in step 3), and mixing uniformly; 5) placing the mixed powder obtained in step 4) into a mold cavity for dry pressing and forming, so as to obtain a sendust core blank, wherein the pressing and forming pressure is 20 T/cm², and the holdup time is 3-5 s; 6) heat treating the pressed blank in a sintering furnace with nitrogen, wherein the specific procedures include roasting the product for 1 h at 500° C., rising to 900° C. and roasting for 60 min; after the product taken from roasting is cooled, spraying a layer of epoxy resin on the surface of the product for preparation of the sendust core.

A method for manufacturing a sendust core using the sendust core material, including the steps of taking the sendust powder to heat to 60-100° C., adding an aqueous solution mixed with chromic acid, phosphoric acid and boric acid into the sendust powder and stirring to allow the two to produce chemical reaction for 30-60 min, and then taking out the reacted sendust powder to roast for 1-2 h at 100-200° C., so as to obtain a first powder; in the process of obtaining the first powder, the mass ratio relationship between the sendust powder and the aqueous solution mixed with chromic acid, phosphoric acid and boric acid is as follows: the mass ratio of the chromic acid to the sendust powder is 0.3%-1.5%, the mass ratio of the phosphoric acid to the sendust powder is 6.0-9.0%, the mass ratio of the boric acid to the sendust powder is 0.3-2.0%, and the mass ratio of the water to the sendust powder is 5.0-10.0%; heat treating the first powder to obtain an intermediate powder; preparing a binder, wherein the binder is composed of sodium silicate, alumina powder, calcium aluminate cement and montmorillonoid, the mass ratio of sodium silicate to alumina powder to calcium aluminate cement to montmorillonoid is (5-6):(2.8-3.5):(1.8-2.5):(0.7-2.0), and the sodium silicate modulus is 1.5-2.5; mixing the binder with the clay powder uniformly, then mixing with the water to make into mixed liquid, and mixing the intermediate powder with the mixed liquid, taking out and drying at 100-150° C. after stirring for 30-60 min, screening with a 60-mesh sieve to obtain a finished powder after drying, wherein the clay powder may be one or mixture of several of mica powder, kaolin powder, montmorillonoid powder and feldspar powder; adding a powdered lubricant into the finished powder, wherein the mass ratio of the powdered lubricant to the finished powder is 0.3-0.7%; uniformly mixing; screening with the 60-mesh sieve, and then placing into a die cavity of a press mold to obtain a blank by pressing, finally heat treating the pressed blank in the sintering furnace to obtain the sendust core. The heat treatment conditions include roasting the blank for 1-5 h at 300-500° C., and then rising to 700-900° C., and roasting for 1-2 h in nitrogen; heat treating the first powder to obtain an intermediate powder, including the steps of placing the first powder in air at 400-600° C. for 1-3 h, so as to obtain a second powder; or placing the first powder in nitrogen at 700-800° C. for 1-3 h, so as to obtain a third powder.

The mass ratio of the binder to the second powder is 1.0-2.5%, the mass ratio of the clay powder to the second powder is 1.0-3.0%, and the mass ratio of the water to the second powder is 5.0-10.0%; or the mass ratio of the binder to the third powder is 1.0-2.5%, the mass ratio of the clay powder to the third powder is 1.0-3.0%, and the mass ratio of the water to the third powder is 5.0-10.0%.

### Embodiment 2a

A method for manufacturing a magnetic powder core using the sendust core material, including the steps of 1) taking atomized sendust powder with 5-20 microns; placing the sendust powder into a stirrer to heat to 60° C., wherein the sendust powder contains 8.5% silicon, 6.3% aluminum and the balance of iron; 2) adding an aqueous solution mixed with phosphoric acid and chromic acid into the sendust powder in step 1), wherein the chromic acid is 0.3% of the sendust powder, the phosphoric acid is 6.0% of the sendust powder, the boric acid is 0.3% of the sendust powder, and the water is 5.0% of the sendust powder; continuously stirring to allow full chemical reaction between the mixture and the sendust powder at 60° C. after addition; roasting the powder for 2.0 h at 100° C. after stirring for 60 min, so as to obtain a sendust powder after being insulated once, namely the first powder; 3) heat treating the powder in step 2) for 2 h at 400° C. in air; 4) preparing a binder, wherein the binder is composed of sodium silicate, alumina powder, calcium aluminate cement and montmorillonoid, the mass ratio of sodium silicate to alumina powder to calcium aluminate cement to montmorillonoid is 5:2.8:1.8:0.7, and the sodium silicate modulus is 1.5; taking the binder, which is 2.5% of the sendust powder; taking the 1250-mesh clay powder, which is 3.0% of the sendust powder; taking water, which is 5.0% of the sendust powder; uniformly mixing the binder, the clay powder and the water; adding the mixture into the powder in step 3), stirring for 60 min at 60° C.; roasting the powder for 2 h at 100° C.; screening the dried powder with the 60-mesh sieve to obtain a finished powder—a fifth powder; 5) adding 0.3% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 5 h at 300° C., rising to 700° C. and roasting for 120 min; after the product taken from roasting is cooled, spraying a layer of epoxy resin on the surface of the product for preparation of the sendust core.

### Embodiment 2b

A method for manufacturing a magnetic powder core using the sendust core material, including the steps of 1) taking atomized sendust powder, with 5-20 microns, which is of a spherical shape; placing the sendust powder into a stirrer to heat to 80° C., wherein the sendust powder contains 9.0% silicon, 6.0% aluminum and the balance of iron; 2) adding an aqueous solution mixed with phosphoric acid and chromic acid into the sendust powder in step 1), wherein the chromic acid is 1.0% of the sendust powder, the phosphoric acid is 8.0% of the sendust powder, the boric acid is 1.5% of the sendust powder, and the water is 7.0% of the sendust powder; continuously stirring to allow full chemical reaction between the mixture and the sendust powder at 80° C. after addition; roasting the powder for 1.5 h at 150° C. after stirring for 40 min, so as to obtain a sendust powder after being insulated once, namely the first powder; 3) heat treating the powder in step 2) for 1.5 h at 500° C. in air; 4) preparing a binder, wherein the binder is composed of sodium silicate, alumina powder, calcium aluminate cement and montmorillonoid, the mass ratio of sodium silicate to alumina powder to calcium aluminate cement to montmorillonoid is 6:3.5:2.5:2.0, and the sodium silicate modulus is 2.0; taking the binder, which is 1.5% of the sendust powder; taking the 1250-mesh clay powder, which is 2.0% of the sendust powder; taking water, which is 7.0% of the sendust powder; uniformly mixing the binder, the clay powder and the water; adding the mixture into the powder in step 3), stirring for 40 min at 80° C.; roasting the powder for 1.5 h at 120° C.; screening the dried powder with the 60-mesh sieve to obtain a finished powder—a fifth powder; 5) adding 0.40% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 120 min at 450° C., rising to 750° C., and roasting for 80 min; after the product taken from roasting is cooled, spraying a layer of epoxy resin on the surface of the product for preparation of the sendust core.

### Embodiment 2c

A method for manufacturing a magnetic powder core using the sendust core material, including the steps of 1) taking atomized sendust powder, with 5-20 microns, which is of a spherical shape; placing the sendust powder into a stirrer to heat to 100° C., wherein the sendust powder contains 10.0% silicon, 5.5% aluminum and the balance of iron; 2) adding an aqueous solution mixed with phosphoric acid and chromic acid into the sendust powder in step 1), wherein the chromic acid is 1.5% of the sendust powder, the phosphoric acid is 9.0% of the sendust powder, the boric acid is 2.0% of the sendust powder, and the water is 10.0% of the sendust powder; continuously stirring to allow full chemical reaction between the mixture and the sendust powder at 100° C. after addition; roasting the powder for 1.0 h at 200° C. after stirring for 30 min, so as to obtain a sendust powder after being insulated once, namely the first powder; 3) heat treating the powder in step 2) for 1 h at 600° C. in air, so as to obtain an intermediate powder—a second powder; 4) preparing a binder, wherein the binder is composed of sodium silicate, alumina powder, calcium aluminate cement and montmorillonoid, the mass ratio of sodium silicate to alumina powder to calcium aluminate cement to montmorillonoid is 6:3.5:2.5:2.0, and the sodium silicate modulus is 2.5; taking the binder, which is 1.0% of the sendust powder; taking the 1250-mesh clay powder, which is 1.0% of the sendust powder; taking water, which is 10% of the sendust powder; uniformly mixing the binder, the clay powder and the water; adding the mixture into the powder in step 3), stirring for 30 min at 100° C.; roasting the powder for 1.0 h at 150° C.; screening the dried powder with the 60-mesh sieve to obtain a finished powder—a fifth powder; 5) adding 0.7% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 1 h at 500° C., rising to 900° C., and roasting for 60 min; after the product taken from roasting is cooled, spraying a layer of epoxy resin on the surface of the product for preparation of the sendust core.

### Embodiment 3a

A method for manufacturing a magnetic powder core using the sendust core material, including the steps of 1) taking atomized sendust powder, with granularity of 5-20 microns, which is of a spherical shape; placing the sendust powder into a stirrer to heat to 60° C., wherein the sendust powder contains 8.5% silicon, 6.3% aluminum and the balance of iron; 2) adding an aqueous solution mixed with phosphoric acid and chromic acid into the sendust powder in step 1), wherein the chromic acid is 0.3% of the sendust powder, the phosphoric acid is 6.0% of the sendust powder, the boric acid is 0.3% of the sendust powder, and the water is 5.0% of the sendust powder; continuously stirring to allow full chemical reaction between the mixture and the sendust powder at 60° C. after addition; roasting the powder for 2 h at 100° C. after stirring for 60 min, so as to obtain a sendust powder after being insulated once, namely the first powder; 3) heat treating the powder in step 2) for 3 h at 700° C. in nitrogen, so as to obtain an intermediate powder—a third powder; 4) preparing a binder, wherein the binder is composed of sodium silicate, alumina powder, calcium aluminate cement and montmorillonoid, the mass ratio of sodium silicate to alumina powder to calcium aluminate cement to montmorillonoid is 5:2.8:1.8:0.7, and the sodium silicate modulus is 1.5; taking the binder, which is 2.5% of the sendust powder; taking the 1250-mesh clay powder, which is 3.0% of the sendust powder; taking water, which is 5.0% of the sendust powder; uniformly mixing the binder, the clay powder and the water; adding the mixture into the powder in step 3), stirring for 60 min at 60° C.; roasting the powder for 2 h at 100° C.; screening the dried powder with the 60-mesh sieve to obtain a finished powder—a sixth powder; 5) adding 0.3% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 120 min at 300° C., rising to 700° C. and roasting for 120 min; after the product taken from roasting is cooled, spraying a layer of epoxy resin on the surface of the product for preparation of the sendust core.

### Embodiment 3b

A method for manufacturing a magnetic powder core using the sendust core material, including the steps of 1) taking atomized sendust powder, with 5-20 microns, which is of a spherical shape; placing the sendust powder into a stirrer to heat to 80° C., wherein the sendust powder contains 9.0% silicon, 6.0% aluminum and the balance of iron; 2) adding an aqueous solution mixed with phosphoric acid and chromic acid into the sendust powder in step 1), wherein the chromic acid is 1.5% of the sendust powder, the phosphoric acid is 8.0% of the sendust powder, the boric acid is 1.5% of the sendust powder, and the water is 7.0% of the sendust powder; continuously stirring to allow full chemical reaction between the mixture and the sendust powder at 80° C. after addition; roasting the powder for 1.5 h at 150° C. after stirring for 40 min, so as to obtain a sendust powder after being insulated once, namely the first powder; 3) heat treating the powder in step 2) for 2 h at 720° C. in nitrogen, so as to obtain an intermediate powder—a third powder; 4) preparing a binder, wherein the binder is composed of sodium silicate, alumina powder, calcium aluminate cement and montmorillonoid, the mass ratio of sodium silicate to alumina powder to calcium aluminate cement to montmorillonoid is 6:3.5:2.5:2.0, and the sodium silicate modulus is 2.0; taking the binder, which is 1.5% of the sendust powder; taking the 1250-mesh clay powder, which is 2.0% of the sendust powder; taking water, which is 7.0% of the sendust powder; uniformly mixing the binder, the clay powder and the water; adding the mixture into the powder in step 3), stirring for 40 min at 80° C.; roasting the powder for 1.5 h at 120° C.; screening the dried powder with the 60-mesh sieve to obtain a finished powder—a sixth powder; 5) adding 0.40% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 120 min at 450° C., rising to 750° C., and roasting for 80 min; after the product taken from roasting is cooled, spraying a layer of epoxy resin on the surface of the product for preparation of the sendust core.

### Embodiment 3c

A method for manufacturing a magnetic powder core using the sendust core material, including the steps of 1) taking atomized sendust powder, with 5-20 microns, which is of a spherical shape; placing the sendust powder into a stirrer to heat to 100° C., wherein the sendust powder contains 10.0% silicon, 5.5% aluminum and the balance of iron; 2) adding an aqueous solution mixed with phosphoric acid and chromic acid into the sendust powder in step 1), wherein the chromic acid is 1.5% of the sendust powder, the phosphoric acid is 9.0% of the sendust powder, the boric acid is 2.0% of the sendust powder, and the water is 10% of the sendust powder; continuously stirring to allow full chemical reaction between the mixture and the sendust powder at 100° C. after addition; roasting the powder for 1.0 h at 200° C. after stirring for 30 min, so as to obtain a sendust powder after being insulated once, namely the first powder; 3) heat treating the powder in step 2) for 1 h at 800° C. in nitrogen, so as to obtain an intermediate powder—a third powder; 4) preparing a binder, wherein the binder is composed of sodium silicate, alumina powder, calcium aluminate cement and montmorillonoid, the mass ratio of sodium silicate to alumina powder to calcium aluminate cement to montmorillonoid is 6:3.5:2.5:2.0, and the sodium silicate modulus is 2.5; taking the binder, which is 1.0% of the sendust powder; taking the 1250-mesh clay powder, which is 1.0% of the sendust powder; taking water, which is 5.0% of the sendust powder; uniformly mixing the binder, the clay powder and the water; adding the mixture into the powder in step 3), stirring for 30 min at 100° C.; roasting the powder for 1 h at 150° C.; screening the dried powder with the 60-mesh sieve to obtain a finished powder—a sixth powder; 5) adding 0.7% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 1 h at 500° C., rising to 900° C., and roasting for 60 min; after the product taken from roasting is cooled, spraying a layer of epoxy resin on the surface of the product for preparation of the sendust core.

A method for manufacturing a sendust core using the sendust core material, including the steps of taking the sendust powder to heat to 60-100° C., adding an aqueous solution mixed with chromic acid, phosphoric acid and boric acid into the sendust powder and stirring to allow the two to produce chemical reaction for 30-60 min, and then taking out the reacted sendust powder to roast for 1-2 h at 100-200° C., so as to obtain a first powder; in the process of obtaining the first powder, the mass ratio relationship between the sendust powder and the aqueous solution mixed with chromic acid, phosphoric acid and boric acid is as follows: the mass ratio of the chromic acid to the sendust powder is 0.3%-1.5%, the mass ratio of the phosphoric acid to the sendust powder is 6.0-9.0%, the mass ratio of the boric acid to the sendust powder is 0.3-2.0%, and the mass ratio of the water to the sendust powder is 5.0-10.0%; placing the first powder in nitrogen at 700-800° C. for 1-3 h, so as to obtain a third powder; adding an acetone mixture with superfine oxide and resin into the air-dried third powder and stirring for 30-60 min to obtain a secondary insulated powder, placing the secondary insulated powder into a ventilated environment, and screening with a 40-mesh sieve to obtain a finished powder when the liquid content in the secondary insulation powder is 1-3%; adding a powdered lubricant into the finished powder, wherein the mass ratio of the powdered lubricant to the finished powder is 0.3-0.7%; uniformly mixing; screening with the 60-mesh sieve; and then placing into a die cavity of a press mold to obtain a blank by pressing, finally heat treating the pressed blank in the sintering furnace to obtain the sendust core. The heat treatment conditions are as follows: roasting the blank for 1-5 h at 300-500° C.; rising to 700-900° C. for sintering in nitrogen, roasting for 1-2 h.

The resin is epoxy resin, phenolic resin or silicone resin; the superfine oxide contains at least one of nanoscale silica, nanoscale alumina, nanoscale magnesium dioxide, mica powder, kaolin, montmorillonoid and kieselguhr, and the particle size of the superfine oxide is less than 20 microns.

The resin is 0.5-2.0% by mass of the third powder, the superfine oxide is 0.8-5.0% by mass of the third powder, and the acetone is 5.0-10.0% by mass of the third powder.

### Embodiment 4a

A method for manufacturing a magnetic powder core using the sendust core material, including the steps of 1) taking atomized sendust powder with 5-20 microns; placing the sendust powder into a stirrer to heat to 60° C., wherein the sendust powder contains 8.5% silicon, 6.3% aluminum and the balance of iron; 2) adding an aqueous solution mixed with phosphoric acid and chromic acid into the sendust powder in step 1), wherein the chromic acid is 0.3% of the sendust powder, the phosphoric acid is 6.0% of the sendust powder, the boric acid is 0.3% of the sendust powder, and the water is 5.0% of the sendust powder; continuously stirring to allow full chemical reaction between the mixture and the sendust powder at 60° C. after addition; roasting the powder for 2 h at 100° C. after stirring for 60 min, so as to obtain a sendust powder after being insulated once, namely the first powder; 3) heat treating the powder in step 2) for 3 h at 700° C. in nitrogen, so as to obtain an intermediate powder—a third powder; 4) taking a superfine oxide, which is 5.0% of the powder in step 3); taking an organic resin (epoxy resin, phenolic resin or silicone resin), which is 2.0% of the powder in step 3); adding the organic resin and the superfine oxide into an acetone solution and uniformly mixing, wherein the acetone is 5% by mass of the powder in step 3); adding a mixture into the powder in step 3), and stirring for about 30 min at room temperature; screening wet powder with a 40-mesh sieve when the liquid content is 1-3% in the powder, and air-drying the powder in a well-ventilated environment to obtain a finished powder—a seventh powder; 5) adding 0.3% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 5 h at 300° C., rising to 700° C. and roasting for 120 min; after the product taken from roasting is cooled, spraying a layer of epoxy resin on the surface of the product for preparation of the sendust core.

### Embodiment 4b

A method for manufacturing a magnetic powder core using the sendust core material, including the steps of 1) taking atomized sendust powder, with 5-20 microns, which is of a spherical shape; placing the sendust powder into a stirrer to heat to 80° C., wherein the sendust powder contains 9.0% silicon, 6.0% aluminum and the balance of iron; 2) adding an aqueous solution mixed with phosphoric acid and chromic acid into the sendust powder in step 1), wherein the chromic acid is 1.5% of the sendust powder, the phosphoric acid is 8.0% of the sendust powder, the boric acid is 2.0% of the sendust powder, and the water is 7.0% of the sendust powder; continuously stirring to allow full chemical reaction between the mixture and the sendust powder at 80° C. after addition; roasting the powder for 1.5 h at 150° C. after stirring for 40 min, so as to obtain a sendust powder after being insulated once, namely the first powder; 3) heat treating the powder in step 2) for 2 h at 720° C. in nitrogen, so as to obtain an intermediate powder—a third powder; 4) taking a superfine oxide (changed as taking a superfine oxide), which is 2.2% of the powder in step 3); taking an organic resin (epoxy resin, phenolic resin or silicone resin), which is 1.2% of the powder in step 3); adding the organic resin and the superfine oxide into an acetone solution and uniformly mixing, wherein the acetone is 8.0% by mass of the powder in step 3); adding the mixture into the powder in step 3), and stirring for about 40 min at room temperature; screening wet powder with a 40-mesh sieve when the liquid content is 1-3% in the powder, and air-drying the powder in a well-ventilated environment to obtain a finished powder—a seventh powder; 5) adding 0.40% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 3 h at 450° C., rising to 750° C., and roasting for 80 min; after the product taken from roasting is cooled, spraying a layer of epoxy resin on the surface of the product for preparation of the sendust core.

### Embodiment 4c

A method for manufacturing a magnetic powder core using the sendust core material, including the steps of 1) taking atomized sendust powder, with 5-20 microns, which is of a spherical shape; placing the sendust powder into a stirrer to heat to 100° C., wherein the sendust powder contains 10.0% silicon, 5.5% aluminum and the balance of iron; 2) adding an aqueous solution mixed with phosphoric acid and chromic acid into the sendust powder in step 1), wherein the chromic acid is 1.5% of the sendust powder, the phosphoric acid is 9.0% of the sendust powder, the boric acid is 2.0% of the sendust powder, and the water is 10.0% of the sendust powder; continuously stirring to allow full chemical reaction between the mixture and the sendust powder at 100° C. after addition; roasting the powder for 1.0 h at 200° C. after stirring for 30 min, so as to obtain a sendust powder after being insulated once, namely the first powder; 3) heat treating the powder in step 2) for 1 h at 800° C. in nitrogen, so as to obtain an intermediate powder—a third powder; 4) taking a superfine oxide, which is 0.8% of the powder in step 3); taking an organic resin (epoxy resin, phenolic resin or silicone resin), which is 0.5% of the powder in step 3); adding the organic resin and the superfine oxide into an acetone solution and uniformly mixing, wherein the acetone is 10.0% by mass of the powder in step 3); adding the mixture into the powder in step 3), and stirring for about 60 min at room temperature to obtain a secondary insulated powder; screening wet powder with a 40-mesh sieve when the liquid content is 1-3% in the secondary insulated powder, and air-drying the powder in a well-ventilated environment to obtain a finished powder—a seventh powder; 5) adding 0.7% powdered lubricant into the powder in step 4), and mixing uniformly; 6) placing the mixed powder obtained in step 5) into a mold cavity for dry pressing and forming, so as to obtain a sendust core blank, wherein the pressing and forming pressure is 20 T/cm², and the holdup time is 3-5 s; 7) heat treating the pressed blank in a sintering furnace with nitrogen, wherein the specific procedures include roasting the product for 1 h at 500° C., rising to 900° C., and roasting for 60 min; after the product taken from roasting is cooled, spraying a layer of epoxy resin on the surface of the product for preparation of the sendust core.

### Embodiment 5

control group 1) taking and placing an ordinary sendust powder with particle size of 200 meshes into a stirrer to heat to 60° C., wherein the sendust powder contains 9.0% silicon, 6.0% aluminum and the balance of iron; 2) adding an aqueous solution mixed with phosphoric acid and chromic acid into the sendust powder in step 1), wherein the chromic acid is 1.5% of the sendust powder, the phosphoric acid is 8.0% of the sendust powder, the boric acid is 1.5% of the sendust powder, and the water is 7.0% of the sendust powder; continuously stirring to allow full chemical reaction between the mixture and the sendust powder at 60° C. after addition; roasting the powder for 1.0-2.0 h at 150° C. after stirring for 30-60 min, so as to obtain a sendust powder after being insulated once; 3) taking a 1250-mesh mica powder, which is 3% of the powder in step 2); taking silicone resin, which is 1.2% of the powder in step 3); adding the silicone resin and the mica powder into an acetone solution and uniformly mixing, wherein an acetone is 10.0% of the powder in step 3); adding the mixture into the powder in step 3), stirring for 30 min at room temperature, screening the wet powder with the 40-mesh sieve when the liquid content is about 1-2% in the powder, and air-drying the powder in a well-ventilated environment; 4) adding 0.40% powdered lubricant into the powder in step 3), mixing uniformly, and then screening with the 60-mesh sieve; 5) placing the mixed powder obtained in step 4) into a mold cavity for dry pressing and forming, so as to obtain a sendust core blank, wherein the pressing and forming pressure is 20 T/cm², and the holdup time is 3-5 s; 6) heat treating the pressed blank in a sintering furnace with nitrogen, wherein the specific procedures include roasting the product for 180 min at 450° C., rising to 750° C. and roasting for 80 min; after the product taken from roasting is cooled, spraying a layer of epoxy resin on the surface of the product for preparation of the sendust core.

The performances of the sendust core obtained by the embodiments of the invention are shown in Table 1 below.

TABLE 1

| | | Pcv | DC superposition |
|---|---|---|---|
| | Magneto- | (mW/cm³) | characteristic |
| Groups | conductivity | (50 kHz/50 mT) | (200 Oe) |
| Embodiment 1a | 23.4 | 54.9 | 72.6% |
| Embodiment 1b | 22.2 | 53.6 | 72.3% |
| Embodiment 1c | 21.8 | 55.7 | 73.1% |
| Embodiment 2a | 19.6 | 48.0 | 75.6% |
| Embodiment 2b | 18.9 | 46.5 | 75.1% |
| Embodiment 2c | 18.4 | 50.1 | 74.5% |
| Embodiment 3a | 19.8 | 50.1 | 75.8% |
| Embodiment 3b | 19.6 | 49.5 | 75.2% |
| Embodiment 3c | 19.1 | 51.7 | 74.9% |
| Embodiment 4a | 20.2 | 47.2 | 75.1% |
| Embodiment 4b | 19.9 | 45.6 | 74.7% |
| Embodiment 4c | 19.3 | 48.9 | 74.2% |
| Embodiment 5 | 21.3 | 65.4 | 65.5% |
| (control group) | | | |

It can be seen from Table 1 that when the performances of the experimental groups 1, 2, 3 and 4 are compared with that of the experimental group 5 (control group) in the invention, the loss of the sendust core obtained by the invention is less than that of the control group, but their DC superposition characteristics are superior to that of the control group.

By taking the superfine sendust powder as the original powder in the experiment, the status and insulation characteristic of an insulating film on the surface of the powder can be improved obviously after the powder is insulated once and roasted at high temperature. This is conducive to improving the density of the formed product, the formability between the powder and the product performance. The binder invented in the experiment can help the powder improve formability, the formed blank strength and product density.

The advantages of the invention are as follows:

The sendust core prepared by the superfine sendust powder is good in electromagnetic property and low in loss, and the DC superposition characteristic of the sendust core can be obviously improved.

When the sendust powder surface is passivated for film forming by combining chromic acid (or chromate), boric acid and phosphoric acid, then the powder is roasted for 1-3 h at constant temperature in air at 400-600° C., an oxidation film on the powder surface is denser, and meanwhile, the passivated film is further solidified and stabilized, so that the density of the oxidation film is improved, the resistivity of the powder surface is improved, and the vortex loss of sendust core is reduced.

A special binder for the metal magnetic powder core is made by mixing sodium silicate and various oxides at a proper ratio. In the secondary insulating process, the binder and the sendust powder in the invention are uniformly combined by a wet mixing process. Firstly, the insulation property of the powder surface can be improved, the resistivity of sendust powder surface can be elevated, and the eddy-current loss can be reduced to improve the quality factor. Secondly, the formability of powder, the density and mechanical strength of the formed blank can be improved, and meanwhile, the mechanical strength of a semi-finished product can be improved after the product is sintered.

The powder treated with the resin and the superfine oxide after being secondary insulated is stirred and mixed in a wet manner for a certain time at room temperature, and then placed in a well-ventilated environment; when the moisture content is 1-3% in the powder, the powder is screened with the 40-mesh sieve, pelleted and air-dried in the well-ventilated environment. The powder thus obtained is good in mobility and is beneficial for blank forming in the press mold.

The pressed blank is heat treated in the sintering furnace in nitrogen. There are two heat treatment temperature sections. In a first section, the heat treatment is conducted for 1-5 h at 300-500° C., and volatile substances are discharged from the blank, so as to preliminarily release inner stress; in a second section, the heat treatment is conducted for 1-2 h at 700-900° C., and the strength of the sintered blank can be improved at such temperature, and meanwhile, the inner stress of the product can be further eliminated to improve the electrical performance of the product. The finished powder in the invention needs air-drying before being mixed with the powdered lubricant which is a micronization wax.

While the invention has been described in terms of preferred embodiments, those skilled in the art will recognize that the invention can be practiced with modifications within the spirit and scope of the appended claims.

What is claimed is:

1. A method for manufacturing a sendust core using a sendust core material including aerosolized sendust powder having granularity of 5-20 microns, having a spherical shape, and having 8.5-10.0% of silicon, 5.5-6.3% of aluminum, and a balance of iron, comprising the steps of:
taking the sendust powder to heat to 60-100° C., adding an aqueous solution mixed with chromic acid, phosphoric acid and boric acid into the powder and stirring to allow the two to produce chemical reaction for 30-60 min, and then taking out the reacted powder to roast for 1-2 h at 100-200° C., so as to obtain a first powder;
preparing a binder, wherein the binder is composed of sodium silicate, alumina powder, calcium aluminate cement and montmorillonoid, the mass ratio of sodium silicate to alumina powder to calcium aluminate cement to montmorillonoid is (5-6):(2.8-3.5):(1.8-2.5):(0.7-2.0), and the sodium silicate modulus is 1.5-2.5;
mixing the binder with the clay powder uniformly, then mixing with the water to make into mixed liquid, and mixing the air-dried first powder with the mixed liquid, wherein the mass ratio of the binder to the first powder is 1.0-2.5%, the mass ratio of the clay powder to the first powder is 2.0-5.0%, and the mass ratio of the water to the first powder is 5.0-10.0%; taking out and drying at 100-150° C. after stirring for 30-60 min, and screening with a 60-mesh sieve to obtain finished powder after drying;
adding a powdered lubricant into the finished powder, uniformly mixing, respectively screening with the 60-mesh sieve, adding the powdered lubricant and mixing uniformly, and then placing into a die cavity of a press mold to obtain a blank by pressing; and
heat treating the pressed blank in a sintering furnace to obtain the sendust core.

2. The method for manufacturing the sendust core of claim 1, wherein, in the process of obtaining the first powder, the mass ratio relationship between the sendust powder and the aqueous solution mixed with chromic acid, phosphoric acid and boric acid is as follows: the mass ratio of the chromic acid to the sendust powder is 0.3%-1.5%, the mass ratio of the phosphoric acid to the sendust powder is 6.0-9.0%, the mass ratio of the boric acid to the sendust powder is 0.5-2.0%, and the mass ratio of the water to the sendust powder is 5.0-10.0%.

3. A method for manufacturing a sendust core using a sendust core material including aerosolized sendust powder having granularity of 5-20 microns, having a spherical shape, and having 8.5-10.0% of silicon, 5.5-6.3% of aluminum, and a balance of iron, comprising the steps of:
taking the sendust powder to heat to 60-100° C., adding an aqueous solution mixed with chromic acid, phosphoric acid and boric acid into the powder and stirring to allow the two to produce chemical reaction for 30-60 min, and then taking out the reacted powder to roast for 1-2 h at 100-200° C., so as to obtain a first powder;
heat treating the first powder to obtain an intermediate powder;
preparing a binder, wherein the binder is composed of sodium silicate, alumina powder, calcium aluminate cement and montmorillonoid, the mass ratio of sodium silicate to alumina powder to calcium aluminate cement to montmorillonoid is (5-6):(2.8-3.5):(1.8-2.5):(0.7-2.0), and the sodium silicate modulus is 1.5-2.5;
mixing the binder with the clay powder uniformly, then mixing with the water to make into mixed liquid, and mixing the intermediate powder with the mixed liquid, taking out and drying at 100-150° C. after stirring for 30-60 min, and screening with the 60-mesh sieve to obtain the finished powder after drying; and
adding a powdered lubricant into the finished powder, uniformly mixing, screening with the 60-mesh sieve, adding the powdered lubricant and mixing uniformly, and then placing into a die cavity of a press mold to obtain a blank by pressing, finally heat treating the pressed blank in the sintering furnace to obtain the sendust core.

4. The method for manufacturing the sendust core of claim 3, wherein the step of heat treating the first powder to obtain the intermediate powder includes the sub-step of placing the first powder in air at 400-600° C. for 1-3 h, so as to obtain a second powder; or placing the first powder in nitrogen at 700-800° C. for 1-3 h, so as to obtain a third powder.

5. The method for manufacturing the sendust core of claim 4, wherein
the mass ratio of the binder to the second powder is 1.0-2.5%, the mass ratio of the clay powder to the second powder is 1.0-3.0%, and the mass ratio of the water to the second powder is 5.0-10.0%; or
the mass ratio of the binder to the third powder is 1.0-2.5%, the mass ratio of the clay powder to the third powder is 1.0-3.0%, and the mass ratio of the water to the third powder is 5.0-10.0%.

6. A method for manufacturing a sendust core using a sendust core material including aerosolized sendust powder having granularity of 5-20 microns, having a spherical shape, and having 8.5-10.0% of silicon, 5.5-6.3% of aluminum, and a balance of iron, comprising the steps of:
taking the sendust powder to heat to 60-100° C., adding an aqueous solution mixed with chromic acid, phosphoric acid and boric acid into the powder and stirring to allow the two to produce chemical reaction for 30-60 min, and then taking out the reacted powder to roast for 1-2 h at 100-200° C., so as to obtain a first powder;
placing the first powder in nitrogen at 700-800° C. for 1-3 h, so as to obtain a third powder;
adding an acetone mixture with superfine oxide and resin into the air-dried third powder and stirring for 30-60 min to obtain a secondary insulated powder, placing the secondary insulated powder into a ventilated environment, and screening with a 40-mesh sieve to obtain a finished powder when the liquid content in the secondary insulation powder is 1-3%; and
adding a powdered lubricant into the finished powder, uniformly mixing, screening with the 60-mesh sieve, and then placing into a die cavity of a press mold to obtain a blank by pressing, finally heat treating the pressed blank in the sintering furnace to obtain the sendust core.

7. The method for manufacturing the sendust core of claim 6, wherein the resin is epoxy resin, phenolic resin or silicone resin; the superfine oxide contains at least one of nanoscale silica, nanoscale alumina, nanoscale magnesium dioxide, mica powder, kaolin, montmorillonoid and kieselguhr, and the particle size of the superfine oxide is less than 20 microns.

8. The method for manufacturing the sendust core of claim 6, wherein the resin is 0.5-2.0% by mass of the third powder, the superfine oxide is 0.8-5.0% by mass of the third powder, and the acetone is 5.0-10.0% by mass of the third powder.
